(19) United States
(12) Patent Application Publication
(10) Pub. No.: US 2023/0147442 A1
(43) Pub. Date: May 11, 2023

(54) Modular Machine Learning Architecture

(71) Applicant: Apple Inc., Cupertino, CA (US)

(72) Inventors: Shujie Liu, San Jose, CA (US); Jiefu Zhai, Sunnyvale, CA (US); Xiaosong Zhou, Campbell, CA (US); Hsi-Jung Wu, San Jose, CA (US); Ke Zhang, Mountain View, CA (US); Xiaoxia Sun, Santa Clara, CA (US); Jian Li, San Jose, CA (US)

(21) Appl. No.: 17/831,738

(22) Filed: Jun. 3, 2022

Related U.S. Application Data
(60) Provisional application No. 63/197,266, filed on Jun. 4, 2021.

(51) Int. Cl. G06N 3/045

(52) U.S. Cl. CPC G06N 3/045

(57) ABSTRACT

In an example method, a system accesses first input data and a machine learning architecture. The machine learning architecture includes a first module having a first neural network, a second module having a second neural network, and a third module having a third neural network. The system generates a first feature set representing a first portion of the first input data using the first neural network, and a second feature set representing a second portion of the first input data using the second neural network. The system generates, using the third neural network, first output data based on the first feature set and the second feature set.

### CROSS-REFERENCE TO RELATED APPLICATION

This application claims priority to U.S. Provisional Pat. Application No. 63/197,266, filed Jun. 4, 2021, the entire contents of which is incorporated herein by reference.

### TECHNICAL FIELD

This disclosure relates generally to training computer systems to perform tasks using machine learning.

### BACKGROUND

Machine learning enables computer systems to learn and adapt to new data without direct human intervention. As an example, using machine learning, a computer system can be trained to identify trends in previously unseen input data, and make a prediction or decision based on the identified trends. In some implementations, a computer system can be trained using supervised learning (e.g., by providing the computer system with labeled training data including sets of training examples, and instructing the computer system to infer a relationship between certain characteristics of input data and a particular desired result). In some implementations, a computer system can be trained using unsupervised learning (e.g., by providing the computer system with unlabeled training data, and instructing the computer system to discover correlations, patterns, or other trends in the data).

### SUMMARY

In an aspect, a method includes accessing first input data; accessing a machine learning architecture including a first module having a first neural network, a second module having a second neural network, and a third module having a third neural network; generating, using the first neural network of the first module, a first feature set representing a first portion of the first input data; generating, using the second neural network of the second module, a second feature set representing a second portion of the first input data; and generating, using the third neural network of the third module, first output data based on the first feature set and the second feature set.

Implementations of this aspect can include one or more of the following features.

In some implementations, the first input data can include a video content.

In some implementations, the first portion can include at least one of: video frames included in the video content, audio included in the video content, depth data included in the video content, or text included in the video content.

In some implementations, the second portion can include at least one of: video frames included in the video content, audio included in the video content, depth data included in the video content, or text included in the video content. The first portion can be different from the second portion.

In some implementations, the first output data can include an indication of an action being performed in the video content.

In some implementations, the first output data can include one of: an indication to present an animation representing the video content to a user, or an indication to present a still image representing the video content to a user.

In some implementations, the first feature set can include a first data vector, and the second feature set can include a second data vector.

In some implementations, the machine learning architecture can further include one or more additional modules having one or more additional neural networks. Further, the method can further include generating, using the one or more additional neural networks of the one or more additional modules, one or more additional feature sets representing one or more additional portions of the first input data. The first output data can be generated further based on the one or more additional feature sets.

In some implementations, the method can include modifying the machine learning architecture to include a fourth module comprising a fourth neural network; and generating, using the fourth neural network of the fourth module, second output data based on the first feature set and the second feature set.

In some implementations, the method can include, subsequent to modifying the machine learning architecture to include a fourth module, refraining from modifying the first neural network and second neural network.

In some implementations, the second output data can be generated further based on the first output data.

In some implementations, the second feature set can be generated further based on the first feature set.

In some implementations, the method can also include generating, using the first neural network of the first module, a plurality of first feature sets representing the first portion of the first input data.

In some implementations, generating the first feature set can include inputting the first portion of the first input data into the first neural network, and receiving an output of the first neural network generated based on the first portion of the first input data.

In some implementations, the machine learning architecture can further include a converter module having a fourth neural network. Generating the first feature set can further include converting, using the fourth neural network of the converter module, the output of the first neural network to the first feature set.

In some implementations, the fourth neural network can be trained to reduce a difference in an output of a first version of the first neural network and a second version of the first neural network. The first version of the first neural can be different from the second version of the first neural network.

In some implementations, at least one of the first neural network or the second neural network can be trained based on training data including a plurality of second content.

In some implementations, at least one of the first neural network or the second neural network can be trained using an unsupervised learning process.

Other implementations are directed to systems, devices, and non-transitory, computer-readable media having instructions stored thereon, that when executed by one or more processors, causes the one or more processors to perform operations described herein.

The details of one or more embodiments are set forth in the accompanying drawings and the description below. Other features and advantages will be apparent from the description and drawings, and from the claims.

### BRIEF DESCRIPTION OF DRAWINGS

FIG. 1 is a diagram of an example modular machine learning architecture.

FIG. 2 is a diagram of an example neural network.

FIG. 3 is a diagram of an example modular machine learning architecture for processing video content.

FIG. 4 is a diagram of another example modular machine learning architecture for processing video content.

FIGS. 5A-5C are diagrams of example operations performed by converter modules.

FIG. 6 is a diagram of an example process for performing one or more tasks using a modular machine learning architecture.

FIG. 7 is a diagram of an example device architecture for implementing the features and processes described in reference to FIGS. 1-6.

### DETAILED DESCRIPTION

In general, a computer system can be configured to perform multiple tasks using a modular machine learning architecture. The modular machine learning architecture includes several intermediate processing modules, each having a respective neural network, and each configured to process input data in a particular manner. The output of the intermediate processing modules can be input into one or more task modules, each having a respective neural network, to perform a particular task.

In some implementations, the modular machine learning architecture can be modified and/or rearranged, without modifying each and every one of its constituent processing modules. As an example, additional task modules can be added to the modular machine learning architecture to enable the computer system to perform additional tasks, without modifying some or all pre-existing processing modules. As another example, a processing module can be modified (e.g., to improve or enhance its performance), while preserving that processing module’s interoperability with the other processing modules of the modular machine learning architecture.

The techniques described herein can provide various technical benefits. For example, a modular machine learning architecture enables a computer system to perform multiple tasks using a common machine leaning architecture, rather than requiring a different respective architecture for each task. Accordingly, a computer system can eliminate (or otherwise reduce) redundancies in performing the tasks, which can result in a reduction in an expenditure of resources. For instance, a computer system can reduce an expenditure of computational resources (e.g., CPU utilization, GPU utilization, etc.), network resources (e.g., bandwidth utilization), memory resources, and/or storage resources, compared to those that would be expended in performing similar tasks using a non-modular machine learning architecture.

As another example, a modular machine learning architecture enables a computer system to be incrementally improved over time in an efficient manner. For instance, a computer system can be modified to perform additional tasks by incrementally adding additional processing modules to the modular machine learning architecture. Further, some or all of pre-existing processing modules in the modular machine learning architecture can be substantially maintained without modification. Accordingly, the capabilities of computer system can be incrementally enhanced over time, while eliminating (or otherwise reducing) the expenditure of resources to modify pre-existing architecture to accommodate the additional functionality.

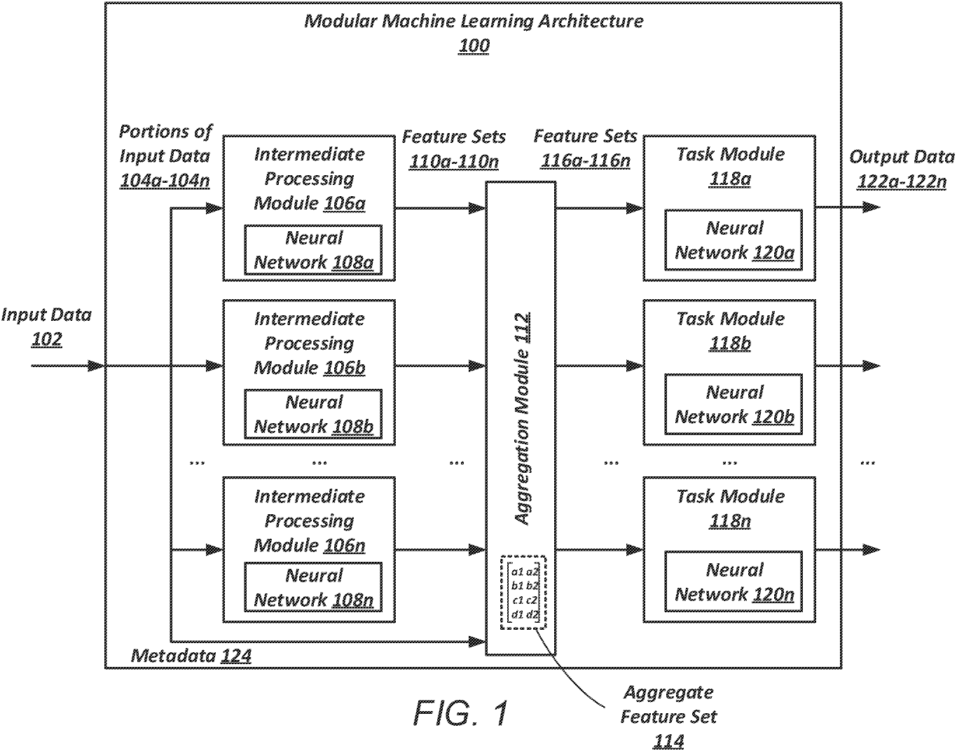

FIG. 1 is a diagram of an example modular machine learning architecture 100 for processing data and performing one or more tasks based on the processed data. The module machine learning architecture 100 can be implemented, for example, using one or more computer systems, such as desktop computers, server computers, portable computers, smart phones, tablet computers, game consoles, wearable computers, set top boxes, media players, smart TVs, three-dimensional displays (e.g., virtual reality headsets, augmented reality headsets, mixed reality headsets, or holographic displays), and the like.

During an example operation, the modular machine learning architecture 100 receives input data 102, processes the input data 102, and generates output data 122a-122n based on the processing. In some implementations, the input data 102 can be include information regarding a particular context, and the output data 122a-122n can indicate one or more predictions, decisions, or actions that are performed by the modular machine learning architecture 100 based on that context.

The modular machine learning architecture 100 generates the output data 122a-122n using several processing modules, each having a respective neural network. An example, as shown in FIG. 1, the modular machine learning architecture 100 can include several intermediate processing modules 106a-106n, each having a respective neural network 108a-108n. In some cases, an intermediate processing module 106a-106n may be referred to as a “backbone” of the modular machine learning architecture 100.

Each of the intermediate processing module 106a-106n is configured to receive a respective portion of the input data 104a-104n, and using its neural network 108a-108n, determine a respective feature set 110a-110n representing that portion of the input data 104a-104n. In some cases, each of the features sets 110a-110n may be referred to as a “embedding.”

In some implementations, each of the feature sets 110a-110n can include a respective data vector or data matrix having one or more dimensions. Further, each dimension can correspond to particular measureable characteristic (or set of characteristics) of the input data. As a simplified example, a feature set can include a three-dimensional

$$\left[\begin{matrix}{a}_{1} \\ {a}_{2} \\ {a}_{3}\end{matrix}\right] ,$$

vector where the values α₁, α₂, and α₃ indicate different respective measureable characteristics of the input data with respect to three different dimensions.

Further, at least some of the feature sets 110a-110n can include temporal information. For example, if the input data 102 includes temporally arranged data (e.g., a temporal sequence of content, such as video content or audio content), at least some of the feature set 110a-110n can include information corresponding to specific temporal portions of the input data 102.

Further, at least some of the feature sets 110a-110n can include spatial information. For example, if the input data 102 includes spatially arranged data (e.g., image content or video content), at least some of the feature set 110a-110n can include information corresponding to specific spatial portions of the input data 102.

In some implementations, each of the feature sets 110a-110n can be a simplified representation of a respective portion of the input data 104a-104n. For example, the intermediate processing module 106a can receive a portion of the input data 104a that is unstructured in nature. Using the neural network 108a, the intermediate processing module 106a can identify a number of discrete dimensions of data that can be used to represent that portion of the input data 104a. Further, the intermediate processing module 106a can generate a feature set 110a having the identified dimensions, and include corresponding values for each of those dimensions (e.g., scalar values) to represent the characteristics of the input data 104a with respect to those dimensions. In some implementations, the resulting feature set 110a can be lower in complexity (e.g., smaller data size, fewer dimensions, etc.) than the corresponding portion of input data 104a.

In some implementations, each of the neural networks 108a-108n can be trained to generate the feature sets 110a-110n using an unsupervised learning process. For example, each of the neural networks 108a-108n can be trained using unlabeled training data (e.g., training data that includes example input data, without any annotations or tags indicating the characteristics, properties, or classifications of that data). The neural networks 108a-108n can automatically identify correlations, patterns, or other trends in the training data that can be used to determine similarities and/or differences in the training data, identify one or more dimensions in the example input data corresponding to identified trends, and determine functions or mathematical relationships to express the characteristics of the training data according to the identified dimensions. Upon completion of the training process, the neural network can be used to process a respective portion of the input data 104a-104n, and generate a feature set according to the identified dimensions, functions, and/or mathematical relationships.

The feature sets 110a-110n are provided to an aggregation module 112, which generates an aggregate feature set 114 representing the input data 102. In some implementations, if each of the feature sets 110a-110n is a data vector or data matrix, the aggregation module 112 can generate an aggregate data vector or data matrix that includes each of the dimensions and corresponding values from the feature sets 110a-110n. As an example, if each of the feature sets 110a-110n is a data vector or data matrix, the aggregation module 112 can generate an aggregate data vector or data matrix that includes each of the dimensions and corresponding values from the data vector or data matrices of the feature sets 110a-110n.

In some implementations, the aggregate module 112 can identify redundancies in the feature sets 110a-110n, and generate an aggregate feature set 114 that eliminates or otherwise reduces the redundancies. As an example, if each of the feature sets 110a-110n is a data vector or data matrix, the aggregation module 112 can identify redundant dimensions between the data vectors or data matrices, and generate an aggregate data vector or data matrix such that those dimensions or eliminated or merged into a fewer number of dimensions.

In some implementations, portions of the input data 102 can be provided directly to the aggregate module 112, without first being processed by an intermediate processing module 106a-106n. For example, as shown in FIG. 1, the input data 102 can include metadata 124 that is provided directly to the aggregation module 112. The metadata 124 (or portions thereof) can be included in the aggregate feature set 114.

The task modules 118a-118n are configured to receive feature sets 116a-116n from the aggregation module 112, and using the neural networks 120a-120n, generate corresponding output data 122a-122n.

In some implementations, at least some of the features sets 116a-116n can include the entirety of the aggregate feature set 114. In some implementations, at least some of the features sets 116a-116n can include only a subset of the aggregate feature set 114.

As discussed above, the output data 122a-122n can indicate one or more predictions, decisions, or actions that are performed by the modular machine learning architecture 100 based on the input data 102.

In some implementations, each of the neural networks 120a-120n can be trained to generate the output data 122a-122n using a supervised learning process. For example, each of the neural networks 120a-120n can be trained using labeled training data including sets of training examples. Each of the training examples can indicate a particular feature set, and a particular desired output in response to the feature set. Using this training data, the neural networks 120a-120n can be trained to infer correlations between certain characteristics of the feature set and a particular desired result, and determine functions or mathematical relationships to express this correlation. Upon completion of the training process, the neural networks 120a-120n can be used to process a respective feature set 116a-116n, and generate output data 122a-122n according to the identified functions and/or mathematical relationships.

In some implementations, the modules of the modular machine learning architecture 100 can be arranged according to a hierarchical structure. For instance, the output of one of the modules can depend, at least in part, on the output of one or more other modules. As an example, referring to FIG. 1, the task module 118a can be arranged hierarchically above the task module 118b, such that the output data 122a that is output by the task module 118a depends, at least in part, on the output data 122b that is output by the task module 118b. As another example, referring to FIG. 1, the intermediate processing module 106a can be arranged hierarchically above the intermediate processing module 106b, such that the feature set 110a that is output by the intermediate processing module 106a depends, at least in part, on the feature set 110b that is output by the intermediate processing module 106b.

In some implementations, portions of the modular machine learning architecture 100 can be adaptively skipped during operation. As an example, referring to FIG. 1, the task module 118a can be arranged hierarchically above the task module 118b, such that the operations of the task module 118a are performed only if the output of the task module 118b satisfies certain criteria. If the output of the task module 118b does not satisfy those criteria, the modular machine learning architecture 100 can refrain from performing the operations of the task module 118a. As an example, referring to FIG. 1, the intermediate processing module 106a can be arranged hierarchically above the intermediate processing module 106b, such that the operations of the intermediate processing module 106a are performed only if the output of the intermediate processing module 106b satisfies certain criteria. If the output of the intermediate processing module 106b does not satisfy those criteria, the modular machine learning architecture 100 can refrain from performing the operations of the intermediate processing module 106a. This can be beneficial, for example, in reducing an expenditure of resources by the modular machine learning architecture 100 when performing tasks.

As described above, in some implementations, the modular machine learning architecture 100 can be modified and/or rearranged, without modifying each and every one of its constituent processing modules. For example, referring to FIG. 1, subsequent to the deployment of the modular machine learning architecture 100, an additional task module (having an additional neural network) can be added to the modular machine learning architecture 100 to generate additional output data based on the aggregate feature set 114 (or a portion thereof). However, the pre-existing intermediate processing modules 106a-106n, the aggregation module 112, and/or the tasks processing modules 118a-118n need not be modified to accommodate the addition of the new task module. For example, the neural networks 108a-108n and/or neural networks 120a-120n can be maintained, and need not be retrained. Instead, the additional task module can retrieve the aggregate feature set 114 (or a portion thereof), and using its neural network, generate additional output data.

As another example, subsequent to the deployment of the modular machine learning architecture 100, one of the task modules 118a-118n can be modified so that it outputs corresponding output data 122a-122n differently. For example, the neural network 120a-120n for that task module 118a-118n can be retrained or otherwise modified such that it uses different feature sets as input and/or performs predictions, decisions, and/or actions differently based on that input. However, the pre-existing intermediate processing modules 106a-106n, the aggregation module 112, and/or the remaining tasks processing modules 118a-118n need not be modified to accommodate the modified task module.

As another example, subsequent to the deployment of the modular machine learning architecture 100, one of the task modules 118a-118n can be removed from the modular machine learning architecture 100 (e.g., to remove functionality from the modular machine learning architecture 100). However, the pre-existing intermediate processing modules 106a-106n, the aggregation module 112, and/or the tasks processing modules 118a-118n need not be modified to accommodate the removal of the task module.

Although FIG. 1 depicts the modular machine learning architecture 100 having n intermediate processing modules 106a-106n, in practice, the modular machine learning architecture 100 can have any number of intermediate processing modules that output any number of feature sets (e.g., one, two, three, four, or more). Further, although FIG. 1 depicts the modular machine learning architecture 100 having n task modules 118a-118n, in practice, the modular machine learning architecture 100 can have any number of task modules that output any number of sets of output data (e.g., one, two, three, four, or more).

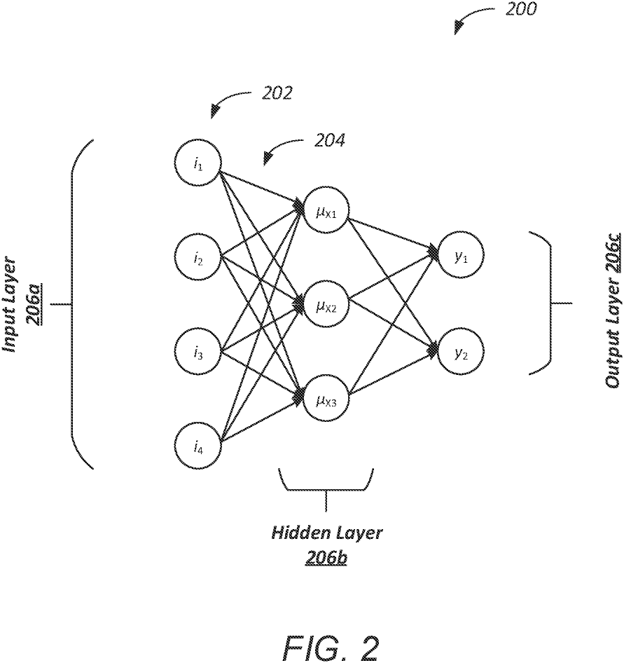

As described above, the modular machine learning architecture 100 can include multiple processing modules, each having a respective neural network. A simplified example of a neural network 200 is shown in FIG. 2.

The neural network 200 includes several nodes 202 (often called “neurons”) interconnected with another by interconnections 204. Further, the nodes 202 are arranged according to multiple layers, including an input layer 206a, a hidden layer 206b, and an output layer 206c. The arrangement of the nodes 202 and the interconnections 204 between them represent a mathematical transformation of input data (e.g., as received by the nodes of the input layer 206a) into corresponding output data (e.g., as output by the nodes of the output layer 206c). In some implementations, the input data can represent one or more portions of input data 104a-104n, and the output data can represent one or more corresponding feature sets 110a-110n generated by the neural network 200 based on the input data (e.g., to implement the functionality described with respect to the neural networks 108a-108n). In some implementations, the input data can represent one or more feature sets 116a-116n, and the output data can represent one or more corresponding sets of output data 122a-122n generated by the neural network 200 based on the input data (e.g., to implement the functionality described with respect to the neural networks 120a-120n).

The nodes 202 of the input layer 206a receive input values and output the received input values to respective nodes of the next layer of the neural network 200. In this example, the neural network 200 includes several inputs i₁, i₂, i₃, and i₄, each of which receives a respective input value and outputs the received value to one or more of the nodes µₓ₁, µₓ₂, and µₓ₃ (e.g., as indicated by the interconnections 204).

The nodes of the hidden layer 206b receive input values (e.g., from the nodes of the input layer 206a or nodes of other hidden layers), applies particular transformations to the received values, and outputs the transformed values to respective nodes of the next layer of the neural network 200 (e.g., as indicated by the interconnections 204). In this example, the neural network 200 includes several nodes µₓ₁, µ_{x2,} and µₓ₃, each of which receives respective input values from the nodes i₁, i₂, i₃, and i₄, applies a respective transformation to the received values, and outputs the transformed values to one or more of the nodes y₁ and y₂.

In some implementations, nodes of the hidden layer 206b can receive one or more input values, and transform the one or more received values according to a mathematical transfer function. As an example, the values that are received by a node can be used as input values in particular transfer function, and the value that is output by the transfer function can be used as the output of the node. In some implementations, a transfer function can be a non-linear function. In some implementations, a transfer function can be a linear function.

In some implementations, a transfer function can weight certain inputs differently than others, such that certain inputs have a greater influence on the output of the node than others. For example, in some implementations, a transfer function can weight each of the inputs by multiplying each of the inputs by a respective coefficient. Further, in some implementations, a transfer function can apply a bias to its output. For example, in some implementations, a transfer function can bias its output by a particular offset value.

For instance, a transfer function of a particular node can be represented as:

$$Y = {\sum }_{i = 1}^{n} \left(w e i g h {t}_{i} ∗ i n p u {t}_{i}\right) + b i a s ,$$

where weightᵢ is the weight that is applied to an input input_{i,} bias is a bias or offset value is that is applied to the sum of the weighted inputs, and Y is the output of the node.

The nodes of the output layer 206c receive input values (e.g., from the nodes of the hidden layer 206b) and output the received values. In some implementations, nodes of the output layer 206c can also receive one or more input values, and transform the one or more received values according to a mathematical transfer function (e.g., in a similar manner as the nodes of the hidden layer 206b). As an example, the values that are received by a node can be used as input values in particular transfer function, and the value that is output by the transfer function can be used as the output of the node. In some implementations, a transfer function can be a non-linear function. In some implementations, a transfer function can be a linear function.

In this example, the neural network 200 includes two output nodes y₁ and y₂, each of which receives respective input values from the nodes µₓ₁, µₓ₂, and µₓ₃, applies a respective transformation to the received values, and outputs the transformed values as outputs of the neural network 152.

Although FIG. 2 shows example nodes and example interconnections between them, this is merely an illustrative example. In practice, a neural network can include any number of nodes that are interconnected according to any arrangement. Further, although FIG. 2 shows a neural network 200 having a single hidden layer 206b, in practice, a network can include any number of hidden layers (e.g., one, two, three, four, or more), or none at all.

Further, in some implementations, the modular machine learning architecture 100 can include one or more types of neural networks. Example types of neural networks include feedforward networks, regulatory feedback networks, radial bias function networks, recurrent neural networks, modular neural networks, transformer neural networks, or any other type of neural network.

In general, the modular machine learning architecture 100 can be used to process any type of input data 102, and generate any type of output data 122a-122n. As an example, the modular machine learning architecture 100 can be used to process input data 102 include video data, audio data, textual data, numerical data, any other type of data, and/or combinations thereof. Further, the modular machine learning architecture 100 can perform any type of prediction, decision, and/or action based on the processed data.

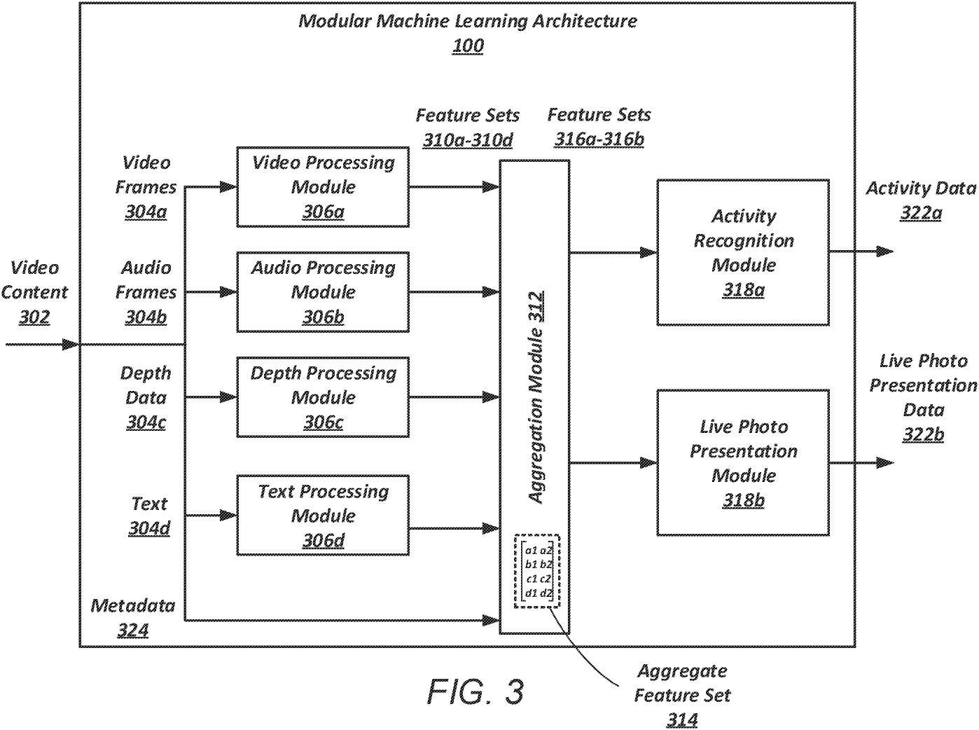

FIG. 3 shows an example configuration of the modular machine learning architecture 100 for processing video content 302. The video content 302 can include several video frames 304a (e.g., pictures, images, or other graphical data that is presented sequentially to a use to represent dynamic or moving visual content). Further, the video content 302 can include several audio frames 304b (e.g., portions of audio content that are presented sequentially to a user to represent auditory content). Further, the video content 302 can include depth data 304c (e.g., data indicating three-dimensional spatial information regarding the video content, such as the apparent depth of certain portions of the video content relative to the user’s viewpoint). Further, the video content 302 can include text data 304d (e.g., textual information, such as captions). Further, the video content 302 can include metadata 324 (e.g., data representing properties of the video content, such as the video content’s length, encoding format, bitrate, frame rate, resolution, title, genre, creator, creation date, modification date, etc.).

In this example, each of the portions of the video content 304a-304d are processed by a different respective processing module 306a-306d, which outputs a different respective feature set 310a-310d (e.g., “embedding”) based on the processed data. For example, a video processing module 306a can retrieve the video frames 304a, process the video frames 304a using a neural network, and output a feature set 310a representing the video frames 304a. As another example, an audio processing module 306b can retrieve the audio frames 304b, process the audio frames 304b using a neural network, and output a feature set 310b representing the audio frames 304b. As another example, a depth processing module 306c can retrieve the depth data 304c, process the depth data 204c using a neural network, and output a feature set 310c representing the depth data 304c. As another example, a depth processing module 306c can retrieve the text data 304d, process the text data 304d using a neural network, and output a feature set 310d representing the text data 304d. In some implementations, each of the feature sets 310a-3 10d can include a respective data vector or data matrix having one or more dimensions.

In general, the video processing module 306a, the audio processing module 306b, the depth processing module 306c, and the text processing module 306d can be similar to the intermediate processing modules 106a-106n described with reference to FIG. 1. For example, each of these modules can include a respective neural network (not shown, of ease of illustration), and can be trained to determine a respective feature set representing a particular portion of the video content 302 (e.g., using an unsupervised training process).

The feature sets 310a-310d are provided to an aggregation module 312, which generates an aggregate feature set 314 representing the video content 302. In general, the aggregation module 312 can be similar to the aggregation module 112 described with reference to FIG. 1. For example, in some implementations, if each of the feature sets 310a-310d is a data vector or data matrix, the aggregation module 312 can generate an aggregate data vector or data matrix that includes each of the dimensions and corresponding values from the feature sets 310a-310d. Further, in some implementations, the aggregate module 312 can identify redundancies in the feature sets 310a-310d, and generate an aggregate feature set 314 that eliminates or otherwise reduces the redundancies.

Further, in some implementations, portions of the video content 302 can be provided directly to the aggregate module 312, without first being processed by a module 306a-306d. For example, as shown in FIG. 3, the video content 302 can include metadata 324 that is provided directly to the aggregation module 312. The metadata 324 (or portions thereof) can be included in the aggregate feature set 314.

The modular machine learning architecture 100 includes modules for generating output data based on the aggregate feature set 314 (or portions thereof).

For example, the modular machine learning architecture 100 includes an activity recognition module 318a including a neural network (not shown, for ease of illustration). The activity recognition module 218a is configured to retrieve a feature set 316a (e.g., including the entirety of or a subset of the aggregate feature set 314), and using its neural network, determine activity data 322a that identifies one or more activities being performed by subjects depicted in the video content 302. As an example, the activity data 322a can indicate whether one or more subjects depicted in the video content are sitting, walking, jogging, running, swimming, playing a sport, waving, or performing any other type of activity.

In some implementations, the activity recognition module 318a can be trained to recognize activities depicted in the video content 302 and generate the activity data 322a using a supervised learning process. For example, the neural network of the activity recognition module 318a can be trained using labeled training data including sets of training examples. Each of the training examples can include a particular feature set that represents a respective instance of video content, and an indication of one or more activities being depicted in that video content. Using this training data, the neural network can be trained to infer correlations between certain characteristics of the feature set and a particular type of activity, and determine functions or mathematical relationships to express this correlation. Upon completion of the training process, the neural network can be used to process a feature set 316a, recognize one or more activities depicted in the video content 302, and generate activity data 322a identifying those activities. The activity data 322a can be provided to other computer architectures and/or devices to facilitate the processing and presentation of the video content 302 to a user.

As another example, the modular machine learning architecture 100 includes a live photo presentation module 318b including a neural network (not shown, for ease of illustration). The live photo presentation module 318b configured to retrieve a feature set 316b (e.g., including the entirety of or a subset of the aggregate feature set 314), and using its neural network, determine live photo presentation data 322b that indicates a particular manner by which a preview of the video content 302 is presented to a user.

For instance, the video content 302 can be a “live photo” that includes both a static image and a short video sequence, both representing the same scene during concurrent (or nearly concurrent) time periods. In some implementations, when a user is browsing through content that includes the live photo (e.g., using a photo gallery user interface on a user device to view previews of one or more instances of content), a preview of the live photo can be presented in the form of the static image (e.g., presented according to a “static mode”) or in the form of the video sequence (or a portion thereof) (e.g., presented according to a “live mode”). The live photo presentation module 318b can determine, for each live photo, whether a preview of that live photo should be presented according to the static mode or the live mode, and generate the live photo presentation data 322b indicating the determined mode of presentation.

In some implementations, the live photo presentation module 318b can be trained to predict a user’s preferred presentation mode for each live photo, and generate the corresponding live photo presentation data 322b using a supervised learning process. For example, the neural network of the live photo presentation module 318b can be trained using labeled training data including sets of training examples. Each of the training examples can include a particular feature set that represents a respective instance of video content (e.g., live photo), and an indication whether a particular user previously preferred to view that video content according to a static mode or a live mode. Using this training data, the neural network can be trained to infer correlations between certain characteristics of the feature set and a preferred preview mode, and determine functions or mathematical relationships to express this correlation. Upon completion of the training process, the neural network can be used to process a feature set 316b, predict a preferred preview mode for the video content 302, and generate live photo presentation data 322b identifying the predicted preview mode.

The live photo presentation data 322b can be provided to other computer architectures and/or devices to facilitate the presentation of the video content 302 to a user. For example, the live photo presentation data 322b can be provided to a user device configured to present content visually to a user. When a user is browsing through the content on the user device (e.g., using a photo gallery user interface on a user device), the user device can determine, based on the live photo presentation data 322b, that a preview of a particular live photo should be presented to the user according to a particular preview mode. Based on this determination, the user device can present a preview of the live photo according to the specified preview mode.

Although FIG. 3 shows two task modules 318a and 318b configured to perform two respective tasks, in practice, the modular machine learning architecture 100 can include any number of modules configured to perform any number of tasks.

As an example, the modular machine learning architecture 100 can include an additional task module configured to retrieve the aggregate feature set 314 (or a portion thereof), process the retrieve feature set using a respective neural network, and generate a prediction regarding the subject matter of the video content (e.g., a semantic description of the video content). The module can generate output data indicating the prediction, and training the output data to one or more other architectures or devices.

As another example, the modular machine learning architecture 100 can include an additional task module configured to retrieve the aggregate feature set 314 (or a portion thereof), process the retrieve feature set using a respective neural network, and generate a prediction regarding the identities of one or more entities or objects depicted in the video content). The module can generate output data indicating the prediction, and training the output data to one or more other architectures or devices.

As another example, the modular machine learning architecture 100 can include an additional task module configured to retrieve the aggregate feature set 314 (or a portion thereof), process the retrieve feature set using a respective neural network, and generate a prediction regarding the location depicted in the video content 302. The module can generate output data indicating the prediction, and training the output data to one or more other architectures or devices.

As another example, the modular machine learning architecture 100 can include an additional task module configured to retrieve the aggregate feature set 314 (or a portion thereof), process the retrieve feature set using a respective neural network, and generate a prediction regarding the spatial position of a subject or a portion thereof (e.g., the subject’s face) within the video content 302. The module can generate output data indicating the prediction, and training the output data to one or more other architectures or devices.

Further, as described above, the modular machine learning architecture 100 can be modified to include additional task modules, remove task modules, and/or modify the operation of particular tasks modules, without requiring that each of the other modules also be modified to accommodate those changes. For example, additional tasks modules can be added to the modular machine learning architecture 100, such that a computer system can perform additional tasks with respect to the video content 302. However, the video processing module 306a, the audio processing module 306b, and depth processing module 306c, and/or the text processing module 306d can remain unchanged (e.g., without retraining each of the neural networks of those processing modules). Accordingly, the modular capabilities of the modular machine learning architecture 100 can be incrementally enhanced over time, by leveraging the pre-existing functionality of the modular machine learning architecture 100.

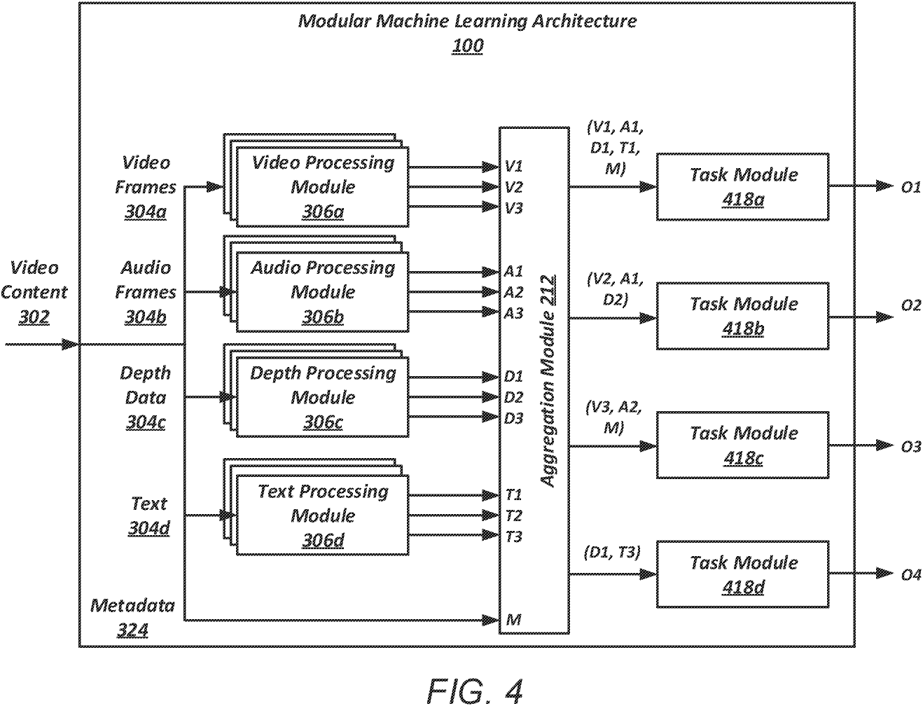

In the example configuration shown in FIG. 4, the modular machine learning architecture 100 has a single respective intermediate processing module for generating feature set for each particular type of data. For example, video frames are processed by a single video processing module 306a, audio frames 306b are processed by a single audio processing module 306b, depth data 304c is processed by a single depth processing module 306c, and text data 304d is processed by a single text processing module 306d. However, in practice, this need not be the case. For example, in some implementations, a single processing module can generate multiple feature sets (e.g., feature sets pertaining to different respective portions of the input data). The generated feature sets can be aggregated by the aggregation module 312.

As another example, in some implementations, each type of data can be processed using several different processing modules, each configured to generate a different respective feature set that represents the data of that type. The generated feature sets can be aggregated by the aggregation module 312. Further, task modules can selectively use different subsets of the aggregate feature set to perform different respective tasks.

As an example, FIG. 4 shows an example configuration of a modular machine learning architecture 100. In general, this example configuration is similar to that shown in FIG. 3.

However, in this example configuration, the modular machine learning architecture 100 includes multiple video processing modules 306a, multiple audio processing modules 306b, multiple depth processing modules 306c, and multiple text processing modules 306d.

For example, the modular machine learning architecture 100 includes three video processing modules 306a, each configured to process the video frames 304a of the video content 302 using a respective neural network (not shown, for ease of illustration), and to generate feature sets V1, V2, and V3 (e.g., data vectors or data matrices) to represent different respective aspects of the video frames 304a.

Further, the modular machine learning architecture 100 includes three audio processing modules 306b, each configured to process the audio frames 304b of the video content 302 using a respective neural network (not shown, for ease of illustration), and to generate feature sets A1, A2, and A3 (e.g., data vectors or data matrices) to represent different respective aspects of the audio frames 304b.

Further, the modular machine learning architecture 100 includes three depth processing modules 306c, each configured to process the depth data 304c of the video content 302 using a respective neural network (not shown, for ease of illustration), and to generate feature sets D1, D2, and D3 (e.g., data vectors or data matrices) to represent different respective aspects of the depth data 304c.

Further, the modular machine learning architecture 100 includes three text processing modules 306d, each configured to process the text data 304d of the video content 302 using a respective neural network (not shown, for ease of illustration), and to generate feature sets T1, T2, and T3 (e.g., data vectors or data matrices) to represent different respective aspects of the text data 304d.

Each of the feature sets are provided to the aggregation module 312 for aggregation into an aggregate feature set. Further, metadata 324 from the video content 302 also can be provided to the aggregation module 312 for inclusion in the aggregate feature set.

In this example configuration shown in FIG. 4, the modular machine learning architecture 100 also includes several tasks modules 418a-418d. In general, the task modules 418a-418d can to similar the task modules 118a-118n, 318a, and 318b described with reference to FIGS. 1 and 3. For example, each of the task modules 418a can retrieve the aggregate feature set (or subsets thereof), process the retrieve feature set using a respective neural network (not shown, for ease of illustration), and output respective output data 01, 02, 03, and 04 (e.g., each representing a different prediction, decision, or action).

For example, the task module 418a can be configured to retrieve the subset of the aggregate feature set corresponding to feature sets V1, A2, D1, T1, and M, process the retrieved data using a respective neural network, and generate output data 01 representing a first prediction, decision, or action made based on the video content 302.

As another example, the task module 418b can be configured to retrieve the subset of the aggregate feature set corresponding to feature sets V2, A1, and D2, process the retrieved data using a respective neural network, and generate output data 02 representing a second prediction, decision, or action made based on the video content 302.

As another example, the task module 418c can be configured to retrieve the subset of the aggregate feature set corresponding to feature sets V3, A2, and M, process the retrieved data using a respective neural network, and generate output data 03 representing a third prediction, decision, or action made based on the video content 302.

As another example, the task module 418d can be configured to retrieve the subset of the aggregate feature set corresponding to feature sets D1 and T3, , process the retrieved data using a respective neural network, and generate output data 04 representing a fourth prediction, decision, or action made based on the video content 302.

As described above, in some implementations, a processing module can be modified (e.g., to improve or enhance its performance), while preserving that processing module’s interoperability with the other processing modules of the modular machine learning architecture 101. In some implemented, this can be performed using one or more converter modules configured to convert the output of the processing module from one set of values or format to another set of values or format.

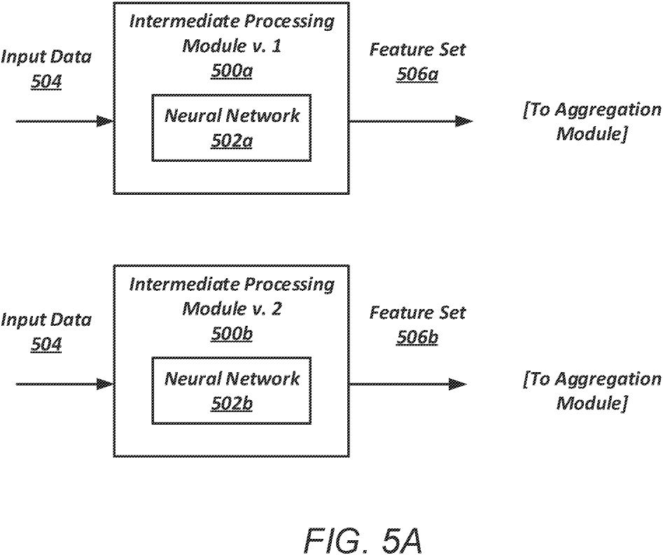

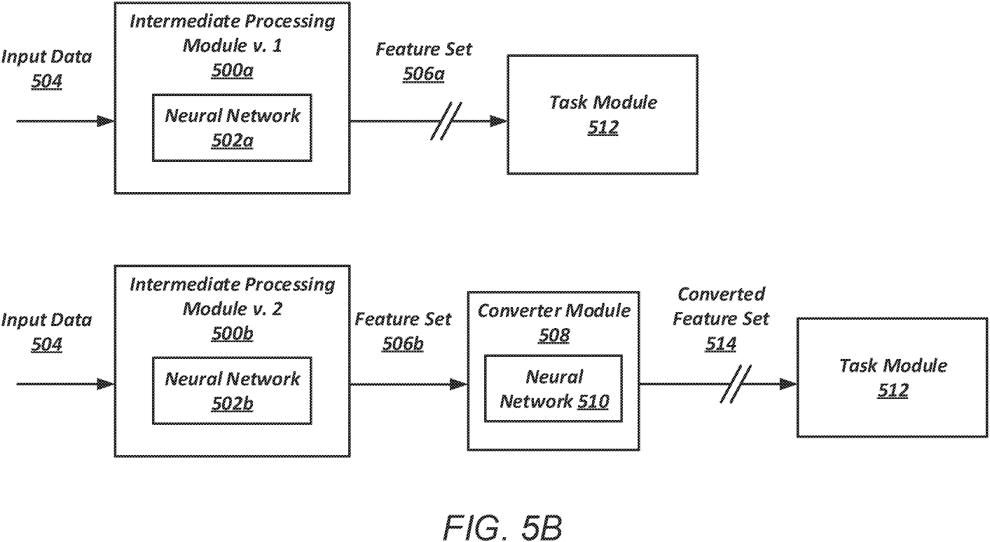

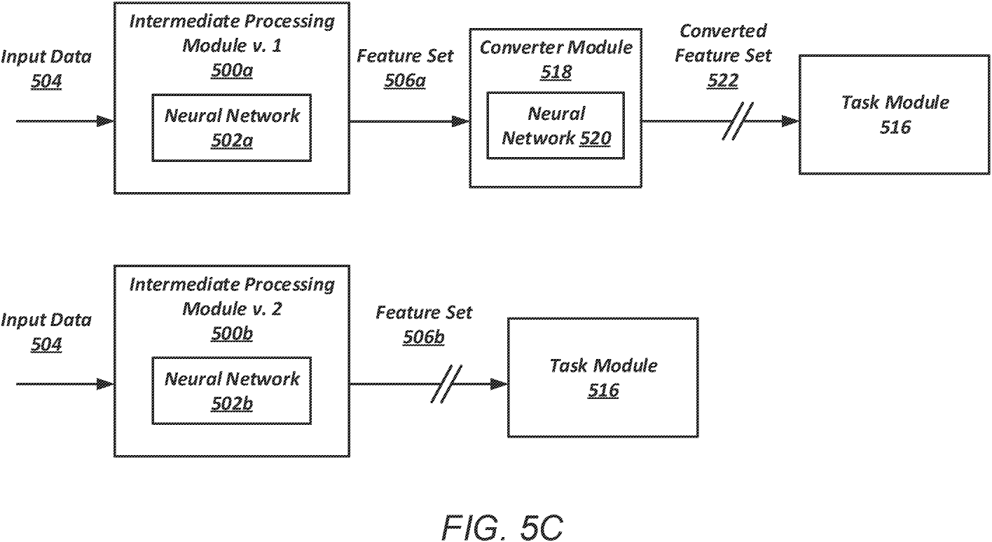

As an example, FIG. 5A shows a first version of an intermediate processing module 500a. In general, the intermedia processing module 500a can be similar to the processing modules 106a-106n and/or 306a-306d described with reference to FIGS. 1, 3, and 4. In this example, the intermediate processing module 500a includes a neural network 502a that is configured to receive input data 504 (e.g., a portion of video content, or some other input data), and generate a feature set 506a based on the input data 504. The feature set 506a can be provided to an aggregation module (e.g., an aggregation module 112 or 122) for further processing.

Further, the intermediate processing module 500b can be subsequently modified. As an example, FIG. 5A shows a second version of an intermediate processing module 500b, including a modified neural network 502b. In some implementations, the modified neural network 502b can be generated by retraining the original neural network 502a (e.g., using a different set of training data and/or according to different training parameters), or otherwise modifying the configuration of the original neural network 502a. In this example, the modified neural network 502b is configured to receive the input data 504, and generate a different feature set 506b based on the input data 504.

In some implementations, a converter module 508 having a neural network 510 can be used to convert the feature set 506a and/or the feature set 506b to maintain an interoperability of the intermediate processing modules 500a and 500b with other modules of the modular machine learning architecture 100.

As an example, as shown in FIG. 5B, a task module 512 may be trained to perform certain tasks based on the output of the first version of the intermediate processing module 500a. If a second version of the intermediate processing module 500b is subsequently deployed in place of the first version of the intermediate processing module 500a, a converter module 508 can be used to convert the feature set 506b that is generated by the second version of the intermediate processing module 500b into a converted feature set 514. The task module 512 can use the converted feature set 514 to perform one or more tasks, without requiring that the task module 514 be retrained to accommodate the second version of the intermediate processing module 500b. Accordingly, intermediate processing modules can be selectively modified over time, without interfering with the operation of pre-existing modules in the modular machine learning architecture 100.

As another example, as shown in FIG. 5C, a task module 516 may be trained to perform certain tasks based on the output of the second version of the intermediate processing module 500b. However, if the second version of the intermediate processing module 500b is subsequently reverted to the earlier first version of the intermediate processing module 500a, a converter module 518 having a neural network 520 can be used to convert the feature set 506a that is generated by the first version of the intermediate processing module 500a into a converted feature set 522. The task module 516 can use the converted feature set 520 to perform one or more tasks, without requiring that the task module 516 be retrained to accommodate the first version of the intermediate processing module 500a. Accordingly, intermediate processing modules can be selectively modified over time, without interfering with the operation of pre-existing modules in the modular machine learning architecture 100.

In some implementations, the neural networks 510 and 520 can be trained to convert feature sets in such a way that a difference between the feature sets output by different versions of an intermediate processing module is minimized (or otherwise reduced). As an example, the neural network can be trained using training data including sets of training examples. Each of the training examples can include a first feature set output by a first version of an intermediate processing module in response to a particular set of input data, and a second feature set output by a second version of an intermediate processing module in response to the same set of input data. Using this training data, the neural network can be trained to infer correlations between the first and second feature sets and determine functions or mathematical relationships to express this correlation. Upon completion of the training process, the neural network can be used to process a feature set output by one version of the intermediate processing module, and generate a corresponding feature set that approximates the feature set that would have been output by the other version of the intermediate processing module.

In some implementations, the neural networks 510 and 520 can be trained to convert feature sets in such a way that a difference between outputs of a task module or multiple task modules that are generated based on feature sets produced by different versions an intermediate processing module is minimized (or other reduced). As an example, the neural network can be trained using training data including sets of training examples. Each of the training examples can include (i) a first output generated by a task module based on a feature set produced by a first version of an intermediate processing module in response to a particular set of input data, and (ii) a second output generated by the same task module based on a feature set produced by a second version of the intermediate processing module in response to the same input data. Using this training data, the neural network can be trained to infer correlations between the feature sets and their corresponding outputs, and determine functions or mathematical relationships to express this correlation. Upon completion of the training process, the neural network can be used to process a feature set produced by one version of the intermediate processing module, and generate a corresponding feature set that, when provided to a particular task module, would result in approximately the same output.

In some implementations, the neural networks 510 and 520 can be trained to convert feature sets according to a bijective or invertible manner. For example, the neural networks 510 and 520 can be trained to convert a first feature set associated with a first version of an intermediate processing module into a corresponding second feature set associated with a second version of that intermediate processing module, and vice versa.

In some implementations, the neural networks 510 and 520 can be trained to convert feature sets representing one type of input data into feature sets representing another type of input data. As an example, the neural networks 510 and 520 can be trained to convert a feature set representing the audio frames of a particular instance of video content into a feature set representing text data of that video content. As an example, the neural networks 510 and 520 can be trained to convert a feature set representing the video frames of a particular instance of video content into a feature set representing the audio frames of that video content.

### Example Processes

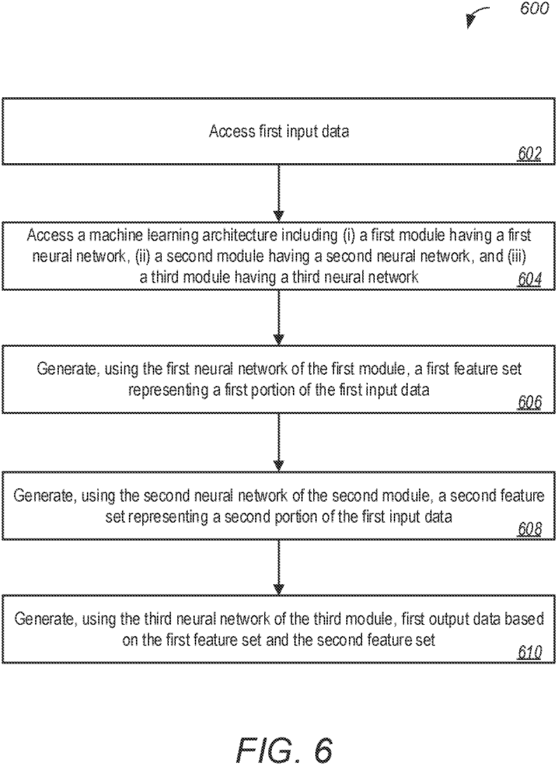

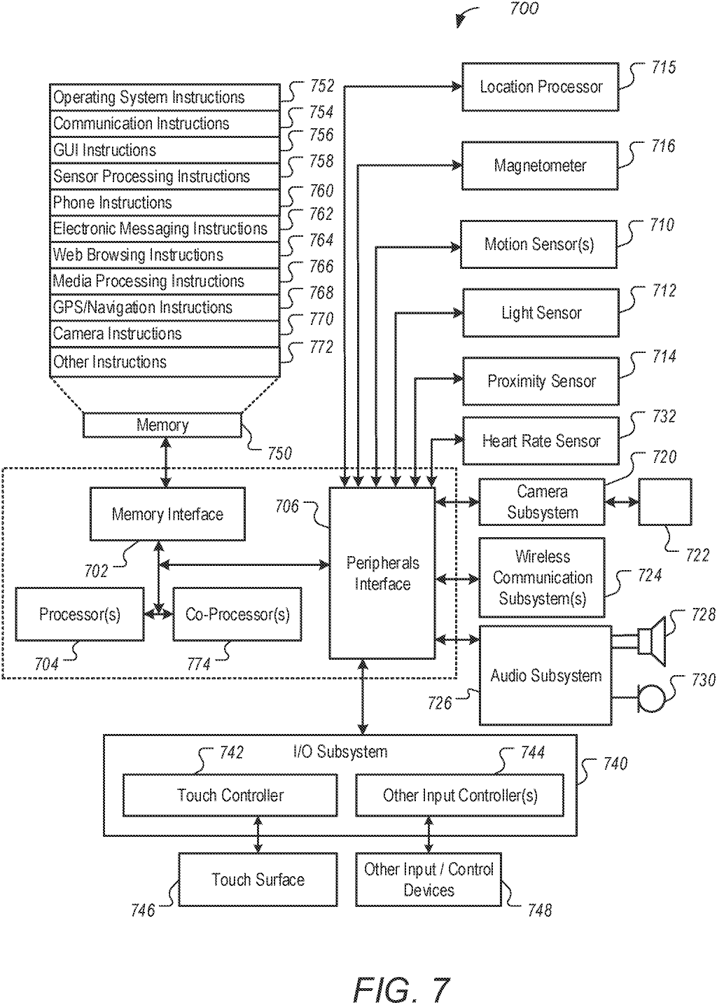

FIG. 6 shows an example process 600 for encoding information regarding a polygon mesh. The process 600 can be performed, at least in part, using one or more computer systems or devices (e.g., one or more of the computer systems shown in FIG. 7).

According to the process 600, a system access first input data (block 602). In some implementations, the first input data can include a video content (e.g., the video content 302 described with reference to FIGS. 3 and 4).

Further, the system accesses a machine learning architecture (block 604). The machine learning architecture includes a first module having a first neural network, a second module having a second neural network, and a third module having a third neural network. Example machine learning architectures are shown in FIGS. 1, 3, and 4. An example neural network is shown in FIG. 2.

The system generates, using the first neural network of the first module, a first feature set representing a first portion of the first input data (block 606).

Further, the system generates, using the second neural network of the second module, a second feature set representing a second portion of the first input data (block 608).

In some implementations, the first feature set can include a first data vector and/or data matrix, and the second feature set can include a second data vector and/or data matrix.

In some implementations, the first module and/or the second module can be intermediate processing modules (e.g., one or more of the intermediate processing modules 106a-106n, as described with reference to FIG. 1).

In some implementations, the first module and/or the second module can be a video processing module (e.g., the video processing module 306a described with reference to FIGS. 3 and 4), and can be used to process a portions of video content that include video frames.

In some implementations, the first module and/or the second module can be an audio processing module (e.g., the audio processing module 306b described with reference to FIGS. 3 and 4), and can be used to process a portions of video content that include audio frames.

In some implementations, the first module and/or the second module can be a depth processing module (e.g., the depth processing module 306c described with reference to FIGS. 3 and 4), and can be used to process a portions of video content that include depth data.

In some implementations, the first module and/or the second module can be a text processing module (e.g., the text processing module 306d described with reference to FIGS. 3 and 4), and can be used to process a portions of video content that include text data.

In some implementations, the first neural network and/or the second neural network can be trained based on training data include a plurality of second content (e.g., one or more additional instances of video content). Further, the first neural network and/or the second neural network can be trained using an unsupervised learning process.

The system generates, using the third neural network of the third module, first output data based on the first feature set and the second feature set (block 610). In some implementations, the third module can be a task module (e.g., a task module 118a-118n, as described with reference to FIG. 1).

In some implementations, the third module can be an activity recognition module (e.g., the activity recognition module 318a described with reference to FIG. 3). Further, the first output data can include an indication of an action being performed in the video content (e.g., one or more activities being performed by subjects depicted in the video content).

In some implementations, the third module can be a live photo presentation module (e.g., the live photo presentation module 318b described with reference to FIG. 3). Further, the first output data can include: (i) an indication to present an animation representing the video content to a user (e.g., an indication to present a live photo according to a “live mode’), or (ii) an indication to present a still image representing the video content to a user (e.g., an indication to present a live photo according to a “static mode”).

In some implementations, the machine learning architecture can further include one or more additional modules having one or more additional neural networks (e.g., one or more additional in4termeidate processing modules). Further, the process 600 can further include generating, using the one or more additional neural networks of the one or more additional modules, one or more additional feature sets representing one or more additional portions of the first input data. Further, the first output data can be generated based on the one or more additional feature sets.

In some implementations, the process 600 can include modifying the machine learning architecture to include a fourth module having a fourth neural network (e.g., an additional task module). Further, the process 600 can include generating, using the fourth neural network of the fourth module, second output data based on the first feature set and the second feature set.

In some implementations, the process 600 can include, subsequent to modifying the machine learning architecture to include a fourth module, refraining from modifying the first neural network and second neural network. For example, the first neural network and the second neural network can be maintained as is, and not retrained in response to the addition of the fourth module.

In some implementations, the second output data can be generated further based on the first output data.

In some implementations, the second feature set can be generated further based on the first feature set.

In some implementations, the process 600 can also include generating, using the first neural network of the first module, a plurality of first feature sets representing the first portion of the first input data.

In some implementations, generating the first feature set can include inputting the first portion of the first input data into the first neural network, and receiving an output of the first neural network generated based on the first portion of the first input data.

Further, the machine learning architecture can include a converter module (e.g., a converter module 518, as described with reference to FIG. 5) having an additional neural network. Generating the first feature set can include converting, using the additional neural network of the converter module, the output of the first neural network to the first feature set. In some implementations, the neural network of the converter module can be trained to reduce a difference in an output of a first version of the first neural network and a second version of the first neural network, where the first version of the first neural is different from the second version of the first neural network.

### Example Computer System

FIG. 7 is a block diagram of an example device architecture 700 for implementing the features and processes described in reference to FIGS. 1-6. For example, the architecture 700 can be used to implement the modular machine learning architecture 100 and/or one or more components thereof. The architecture 700 may be implemented in any device for generating the features described in reference to FIGS. 1-6, including but not limited to desktop computers, server computers, portable computers, smart phones, tablet computers, game consoles, wearable computers, set top boxes, media players, smart TVs, three-dimensional displays (e.g., virtual reality headsets, augmented reality headsets, mixed reality headsets, or holographic displays), and the like.

The architecture 700 can include a memory interface 702, one or more data processor 704, one or more data co-processors 774, and a peripherals interface 706. The memory interface 702, the processor(s) 704, the co-processor(s) 774, and/or the peripherals interface 706 can be separate components or can be integrated in one or more integrated circuits. One or more communication buses or signal lines may couple the various components.

The processor(s) 704 and/or the co-processor(s) 774 can operate in conjunction to perform the operations described herein. For instance, the processor(s) 704 can include one or more central processing units (CPUs) that are configured to function as the primary computer processors for the architecture 700. As an example, the processor(s) 704 can be configured to perform generalized data processing tasks of the architecture 700. Further, at least some of the data processing tasks can be offloaded to the co-processor(s) 774. For example, specialized data processing tasks, such as processing motion data, processing image data, encrypting data, and/or performing certain types of arithmetic operations, can be offloaded to one or more specialized co-processor(s) 774 for handling those tasks. In some cases, the processor(s) 704 can be relatively more powerful than the co-processor(s) 774 and/or can consume more power than the co-processor(s) 774. This can be useful, for example, as it enables the processor(s) 704 to handle generalized tasks quickly, while also offloading certain other tasks to co-processor(s) 774 that may perform those tasks more efficiency and/or more effectively. In some cases, a co-processor(s) can include one or more sensors or other components (e.g., as described herein), and can be configured to process data obtained using those sensors or components, and provide the processed data to the processor(s) 704 for further analysis.

Sensors, devices, and subsystems can be coupled to peripherals interface 706 to facilitate multiple functionalities. For example, a motion sensor 710, a light sensor 712, and a proximity sensor 714 can be coupled to the peripherals interface 706 to facilitate orientation, lighting, and proximity functions of the architecture 700. For example, in some implementations, a light sensor 712 can be utilized to facilitate adjusting the brightness of a touch surface 746. In some implementations, a motion sensor 710 can be utilized to detect movement and orientation of the device. For example, the motion sensor 710 can include one or more accelerometers (e.g., to measure the acceleration experienced by the motion sensor 710 and/or the architecture 700 over a period of time), and/or one or more compasses or gyros (e.g., to measure the orientation of the motion sensor 710 and/or the mobile device). In some cases, the measurement information obtained by the motion sensor 710 can be in the form of one or more a time-varying signals (e.g., a time-varying plot of an acceleration and/or an orientation over a period of time). Further, display objects or media may be presented according to a detected orientation (e.g., according to a “portrait” orientation or a “landscape” orientation). In some cases, a motion sensor 710 can be directly integrated into a co-processor 774 configured to processes measurements obtained by the motion sensor 710. For example, a co-processor 774 can include one more accelerometers, compasses, and/or gyroscopes, and can be configured to obtain sensor data from each of these sensors, process the sensor data, and transmit the processed data to the processor(s) 704 for further analysis.

Other sensors may also be connected to the peripherals interface 706, such as a temperature sensor, a biometric sensor, or other sensing device, to facilitate related functionalities. As an example, as shown in FIG. 7, the architecture 700 can include a heart rate sensor 732 that measures the beats of a user’s heart. Similarly, these other sensors also can be directly integrated into one or more co-processor(s) 774 configured to process measurements obtained from those sensors.

A location processor 715 (e.g., a GNSS receiver chip) can be connected to the peripherals interface 706 to provide geo-referencing. An electronic magnetometer 716 (e.g., an integrated circuit chip) can also be connected to the peripherals interface 706 to provide data that may be used to determine the direction of magnetic North. Thus, the electronic magnetometer 716 can be used as an electronic compass.

A camera subsystem 720 and an optical sensor 722 (e.g., a charged coupled device [CCD] or a complementary metal-oxide semiconductor [CMOS] optical sensor) can be utilized to facilitate camera functions, such as recording photographs and video clips.

Communication functions may be facilitated through one or more communication subsystems 724. The communication subsystem(s) 724 can include one or more wireless and/or wired communication subsystems. For example, wireless communication subsystems can include radio frequency receivers and transmitters and/or optical (e.g., infrared) receivers and transmitters. As another example, wired communication system can include a port device, e.g., a Universal Serial Bus (USB) port or some other wired port connection that can be used to establish a wired connection to other computing devices, such as other communication devices, network access devices, a personal computer, a printer, a display screen, or other processing devices capable of receiving or transmitting data.

The specific design and implementation of the communication subsystem 724 can depend on the communication network(s) or medium(s) over which the architecture 700 is intended to operate. For example, the architecture 700 can include wireless communication subsystems designed to operate over a global system for mobile communications (GSM) network, a GPRS network, an enhanced data GSM environment (EDGE) network, 802.x communication networks (e.g., Wi-Fi, Wi-Max), code division multiple access (CDMA) networks, NFC and a Bluetooth™ network. The wireless communication subsystems can also include hosting protocols such that the architecture 700 can be configured as a base station for other wireless devices. As another example, the communication subsystems may allow the architecture 700 to synchronize with a host device using one or more protocols, such as, for example, the TCP/IP protocol, HTTP protocol, UDP protocol, and any other known protocol.

An audio subsystem 726 can be coupled to a speaker 728 and one or more microphones 730 to facilitate voice-enabled functions, such as voice recognition, voice replication, digital recording, and telephony functions.

An I/O subsystem 740 can include a touch controller 742 and/or other input controller(s) 744. The touch controller 742 can be coupled to a touch surface 746. The touch surface 746 and the touch controller 742 can, for example, detect contact and movement or break thereof using any of a number of touch sensitivity technologies, including but not limited to capacitive, resistive, infrared, and surface acoustic wave technologies, as well as other proximity sensor arrays or other elements for determining one or more points of contact with the touch surface 746. In one implementation, the touch surface 746 can display virtual or soft buttons and a virtual keyboard, which can be used as an input/output device by the user.

Other input controller(s) 744 can be coupled to other input/control devices 748, such as one or more buttons, rocker switches, thumb-wheel, infrared port, USB port, and/or a pointer device such as a stylus. The one or more buttons (not shown) can include an up/down button for volume control of the speaker 728 and/or the microphone 730.

In some implementations, the architecture 700 can present recorded audio and/or video files, such as MP3, AAC, and MPEG video files. In some implementations, the architecture 700 can include the functionality of an MP3 player and may include a pin connector for tethering to other devices. Other input/output and control devices may be used.

A memory interface 702 can be coupled to a memory 750. The memory 750 can include high-speed random access memory or non-volatile memory, such as one or more magnetic disk storage devices, one or more optical storage devices, or flash memory (e.g., NAND, NOR). The memory 750 can store an operating system 752, such as Darwin, RTXC, LINUX, UNIX, OS X, WINDOWS, or an embedded operating system such as VxWorks. The operating system 752 can include instructions for handling basic system services and for performing hardware dependent tasks. In some implementations, the operating system 752 can include a kernel (e.g., UNIX kernel).

The memory 750 can also store communication instructions 754 to facilitate communicating with one or more additional devices, one or more computers or servers, including peer-to-peer communications. The communication instructions 754 can also be used to select an operational mode or communication medium for use by the device, based on a geographic location (obtained by the GPS/Navigation instructions 768) of the device. The memory 750 can include graphical user interface instructions 756 to facilitate graphic user interface processing, including a touch model for interpreting touch inputs and gestures; sensor processing instructions 758 to facilitate sensor-related processing and functions; phone instructions 760 to facilitate phone-related processes and functions; electronic messaging instructions 762 to facilitate electronic-messaging related processes and functions; web browsing instructions 764 to facilitate web browsing-related processes and functions; media processing instructions 766 to facilitate media processing-related processes and functions; GPS/Navigation instructions 769 to facilitate GPS and navigation-related processes; camera instructions 770 to facilitate camera-related processes and functions; and other instructions 772 for performing some or all of the processes described herein.

Each of the above identified instructions and applications can correspond to a set of instructions for performing one or more functions described herein. These instructions need not be implemented as separate software programs, procedures, or modules. The memory 750 can include additional instructions or fewer instructions. Furthermore, various functions of the device may be implemented in hardware and/or in software, including in one or more signal processing and/or application specific integrated circuits (ASICs).

The features described may be implemented in digital electronic circuitry or in computer hardware, firmware, software, or in combinations of them. The features may be implemented in a computer program product tangibly embodied in an information carrier, e.g., in a machine-readable storage device, for execution by a programmable processor; and method steps may be performed by a programmable processor executing a program of instructions to perform functions of the described implementations by operating on input data and generating output.

The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer may communicate with mass storage devices for storing data files. These mass storage devices may include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user the features may be implemented on a computer having a display device such as a CRT (cathode ray tube) or LCD (liquid crystal display) monitor for displaying information to the author and a keyboard and a pointing device such as a mouse or a trackball by which the author may provide input to the computer.

The features may be implemented in a computer system that includes a back-end component, such as a data server or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include a LAN, a WAN and the computers and networks forming the Internet.

The computer system may include clients and servers. A client and server are generally remote from each other and typically interact through a network. The relationship of client and server arises by virtue of computer programs running on the respective computers and having a client-server relationship to each other.

One or more features or steps of the disclosed embodiments may be implemented using an Application Programming Interface (API). An API may define on or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

As described above, some aspects of the subject matter of this specification include gathering and use of data available from various sources to improve services a mobile device can provide to a user. The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

In the case of advertisement delivery services, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

A number of implementations have been described. Nevertheless, it will be understood that various modifications may be made. Elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

1. A method comprising:
accessing first input data;
accessing a machine learning architecture comprising:
a first module comprising a first neural network,
a second module comprising a second neural network, and
a third module comprising a third neural network;
generating, using the first neural network of the first module, a first feature set representing a first portion of the first input data;
generating, using the second neural network of the second module, a second feature set representing a second portion of the first input data; and
generating, using the third neural network of the third module, first output data based on the first feature set and the second feature set.

2. The method of claim 1, wherein the first input data comprises a video content.

3. The method of claim 2, wherein the first portion comprises at least one of:
video frames included in the video content,
audio included in the video content,
depth data included in the video content, or
text included in the video content.

4. The method claim 3, wherein the second portion comprises at least one of:
video frames included in the video content,
audio included in the video content,
depth data included in the video content, or
text included in the video content, and
wherein the first portion is different from the second portion.

5. The method of claim 2, wherein the first output data comprises an indication of an action being performed in the video content.

6. The method of claim 2, wherein the first output data comprises one of:
an indication to present an animation representing the video content to a user, or
an indication to present a still image representing the video content to a user.

7. The method of claim 1, wherein the first feature set comprises a first data vector, and wherein the second feature set comprises a second data vector.

8. The method of claim 1,
wherein the machine learning architecture further comprises one or more additional modules comprising one or more additional neural networks, and
wherein the method further comprises generating, using the one or more additional neural networks of the one or more additional modules, one or more additional feature sets representing one or more additional portions of the first input data, and
wherein the first output data is generated further based on the one or more additional feature sets.

9. The method of claim 1, further comprising:
modifying the machine learning architecture to include a fourth module comprising a fourth neural network; and
generating, using the fourth neural network of the fourth module, second output data based on the first feature set and the second feature set.

10. The method of claim 9, further comprising:
subsequent to modifying the machine learning architecture to include a fourth module, refraining from modifying the first neural network and second neural network.

11. The method of claim 9, wherein the second output data is generated further based on the first output data.

12. The method of claim 1, wherein the second feature set is generated further based on the first feature set.

13. The method of claim 1, further comprising generating, using the first neural network of the first module, a plurality of first feature sets representing the first portion of the first input data.

14. The method of claim 1, wherein generating the first feature set comprises:
inputting the first portion of the first input data into the first neural network, and
receiving an output of the first neural network generated based on the first portion of the first input data.

15. The method of claim 14, wherein the machine learning architecture further comprises a converter module having a fourth neural network, and
wherein generating the first feature set further comprises converting, using the fourth neural network of the converter module, the output of the first neural network to the first feature set.

16. The method of claim 15, wherein the fourth neural network is trained to reduce a difference in an output of a first version of the first neural network and a second version of the first neural network, wherein the first version of the first neural is different from the second version of the first neural network.

17. The method of claim 1, wherein at least one of the first neural network or the second neural network is trained based on training data comprising a plurality of second content.

18. The method of claim 1, wherein at least one of the first neural network or the second neural network is trained using an unsupervised learning process.

19. A device comprising:
one or more processors; and
memory storing instructions that when executed by the one or more processors, cause the one or more processors to perform operations comprising:
accessing first input data;
accessing a machine learning architecture comprising:
a first module comprising a first neural network,
a second module comprising a second neural network, and
a third module comprising a third neural network;
generating, using the first neural network of the first module, a first feature set representing a first portion of the first input data;
generating, using the second neural network of the second module, a second feature set representing a second portion of the first input data; and
generating, using the third neural network of the third module, first output data based on the first feature set and the second feature set.

20-36. (canceled)

37. One or more non-transitory, computer-readable storage media having instructions stored thereon, that when executed by one or more processors, cause the one or more processors to perform operations comprising:
accessing first input data;
accessing a machine learning architecture comprising:
a first module comprising a first neural network,
a second module comprising a second neural network, and
a third module comprising a third neural network;
generating, using the first neural network of the first module, a first feature set representing a first portion of the first input data;
generating, using the second neural network of the second module, a second feature set representing a second portion of the first input data; and
generating, using the third neural network of the third module, first output data based on the first feature set and the second feature set.

38. The one or more non-transitory, computer-readable storage media of claim 37, wherein the first input data comprises a video content.

39. The one or more non-transitory, computer-readable storage media of claim 38, wherein the first portion comprises at least one of:
video frames included in the video content,
audio included in the video content,
depth data included in the video content, or
text included in the video content.

40. The one or more non-transitory, computer-readable storage media claim 39, wherein the second portion comprises at least one of:
video frames included in the video content,
audio included in the video content,
depth data included in the video content, or
text included in the video content, and
wherein the first portion is different from the second portion.

41-54. (canceled)
